(19) United States
(12) Patent Application Publication
(10) Pub. No.: US 2026/0113792 A1
(43) Pub. Date: Apr. 23, 2026

(54) NETWORK-EMBEDDED MACHINE LEARNING PREDICTIONS OF ESTABLISHMENT CAUSE INFORMATION IN RADIO RESOURCE MESSAGING

(71) Applicant: T-Mobile USA, Inc., Bellevue, WA (US)

(72) Inventors: Ramesh Venkata Josyula, Redmond, WA (US); Amembal Vikram Pai, Bothell, WA (US); Satish Pachalla, Sammamish, WA (US); Roopesh Kumar Polaganga, Bothell, WA (US)

(21) Appl. No.: 18/923,273

(22) Filed: Oct. 22, 2024

(51) Int. Cl. H04W 76/14

(52) U.S. Cl. CPC H04W 76/14

(57) ABSTRACT

Existing radio access network (RAN) operations are generally reactive. Network-embedded prediction implementations improve RAN operations by enabling proactive cell site operations, particularly with respect to initiating and configuring new radio resource configuration (RRC) sessions with wireless devices in cell sites. In an example implementation, access class barring operation of a network node of a RAN is improved through predictions of establishment cause information included in new RRC setup requests. The predictions can be based upon historical trends as well as various features such as device model, as establishment cause information may be indicated by wireless devices in a model-specific manner. Based on a predicted distribution of enumerated establishment causes, a network node can adjust access class barring thresholds.

### BACKGROUND

In modern telecommunications networks, the efficient allocation and management of radio resources are critical for maintaining high-quality service and user satisfaction. Users joining a network have diverse service requirements that vary widely based on their activities and applications. As some examples, some users may join a network to engage in voice calls, while others need the network's communications services for data-intensive applications such as video streaming, online gaming, or cloud services. Diversity in service requirements necessitates a flexible and efficient approach to radio resource management to ensure that all users receive the appropriate level of service quality.

Radio resource management in telecommunications network can be provided at least in part by Radio Resource Control (RRC) setup, which is the initial step that allows a user device, or User Equipment (UE), to establish communication with a base station. During the RRC setup process, the UE and the network exchange a series of messages to configure the necessary parameters for communication. This includes an allocation of radio resources, security configurations, and the establishment of signaling connections. The RRC setup can lay the foundation for all subsequent interactions between the UE and the network.

### BRIEF DESCRIPTION OF THE DRAWINGS

Detailed descriptions of implementations of the present invention will be described and explained through the use of the accompanying drawings.

FIG. 1 is a diagram illustrating an example cell site operation based on radio resource configuration (RRC) messaging.

FIG. 2 is a block diagram that illustrates a wireless communications system that can implement aspects of the present technology.

FIG. 3 is a block diagram that illustrates 5G core network functions (NFs) that can implement aspects of the present technology.

FIG. 4A illustrates an example process involving RRC messages that include establishment cause information.

FIG. 4B illustrates an example of establishment cause information included in radio resource messaging.

FIGS. 5A-5B are flow diagrams illustrating example operations for network-embedded predictions of establishment cause information in radio resource messages.

FIG. 6A illustrates an example process involving RRC messages that include establishment cause information.

FIG. 6B illustrates an example of establishment cause information included in radio resource messages.

FIGS. 7A-7C and FIG. 8 illustrate example prediction model outputs including predictions of establishment cause information in radio resource messages.

FIG. 9 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The present disclosure provides technical solutions for predicting establishment cause information in radio resource configuration (RRC) messaging in mobile networks on a per-cell level granularity based on machine learning. Predictions on the establishment causes of incoming users, as well as the associated service priorities, enable proactive radio resource planning and allocation.

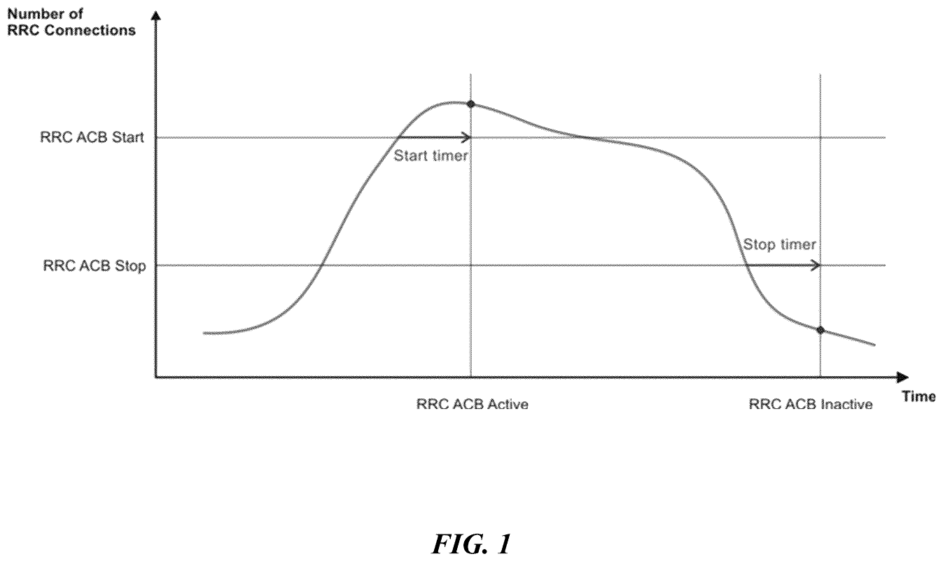

Existing techniques and systems for managing network resources, within a radio access network (RAN) for example, are generally reactive to changes in user loads. FIG. 1, for example, illustrates a technique for access class barring (ACB), in which certain wireless devices (or user equipment, UE) may be barred or blocked from connecting to a particular RAN cell site for a period of time due to a high number of other wireless devices with higher priority identities (e.g., emergency operators) are being served by the particular RAN cell site. In the example implementation of FIG. 1, an ACB time period is triggered after, or in reaction to, a number of higher priority wireless devices being served by the particular RAN cell site exceeds a first threshold (“RRC ACB Start”). Then, the ACB time period is ended after, or in reaction to, the number of higher priority wireless devices being served by the particular RAN cell site decreases below a second threshold (“RRC ACB Stop”).

Other examples of reactive or on-the-fly operations include network handling of emergency calls. In existing systems, a network node may reserve a set of resources (e.g., 10% of its radio resource pool) at all times to anticipate an unknown number of possible emergency calls in an upcoming time period. Similarly, a network node may reserve a set of resources (e.g., 20% of its radio resource pool) at all times to anticipate an unknown number of possible handovers it may receive. These resource allocations are static and not well-optimized.

The technical solutions disclosed herein improve upon these existing technique by enabling proactive cell site operations using machine learning (ML) predictions of establishment cause information included in radio resource configuration (RRC) messages between wireless devices (or UEs) and RAN network nodes operating cell sites. Establishment cause information represents granular yet actionable information based on which networks can efficiently and accurately steer their operations and configurations. In contrast, for example, random access channel (RACH) process is a different parameter that, by itself, may be too granular to accurately predict the incoming traffic and act upon (e.g., due to its randomness). Furthermore, predicting and acting upon RACH processes for incoming traffic is vulnerable to “RACH storm” problems in which a problematic UE from another network sends constant RACH to network nodes. And RACH procedure does not provide any actionable insights as to whether incoming traffic is emergency or non-emergency, for example.

On the other hand, simply predicting overall network traffic utilization trends for a given cell is too broad to be provide actionable short-term adjustments, compared to the disclosed embodiments directed to establishment causes. While predictions on overall traffic utilization can give a sense of what to expect in the future to some extent, short-term adjustments such as optimizing RRC state transitions or paging strategies cannot be accurately executed, due to the combinations of all types of devices and applications within the predictions. For example, one single ‘Home internet’ device on a cell could congest it (especially on smaller FDD bandwidth cells) but may not reveal the reality on the network needs and behavior of other incoming users.

Given these limitations, predicting the establishment cause is unique and advantageous than predicting other metrics, especially when it comes to admission control aspects and improving proactivity of network service.

Additionally, the disclosed ML-based solutions can be implemented at the RAN network nodes and therefore provide ML intelligence embedded into the network, further facilitating the proactivity of cell site operations. Current network operations that may rely upon ML intelligence (e.g., energy savings with traffic predictions, interference management, beam selection, handover optimization, anomaly detection for fault management) generally rely upon remote implementations of AI/ML models (e.g., in centralized datacenters like a cloud platform), and current network systems do not implement AI/ML models locally at least within the RAN.

Therefore, the disclosed implementations provide technical benefits enjoyed by a telecommunications network through improved RAN load distribution, as well as benefits enjoyed by network subscribers with improved quality of network connections and services.

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

### Example Implementations of Wireless Communications Systems

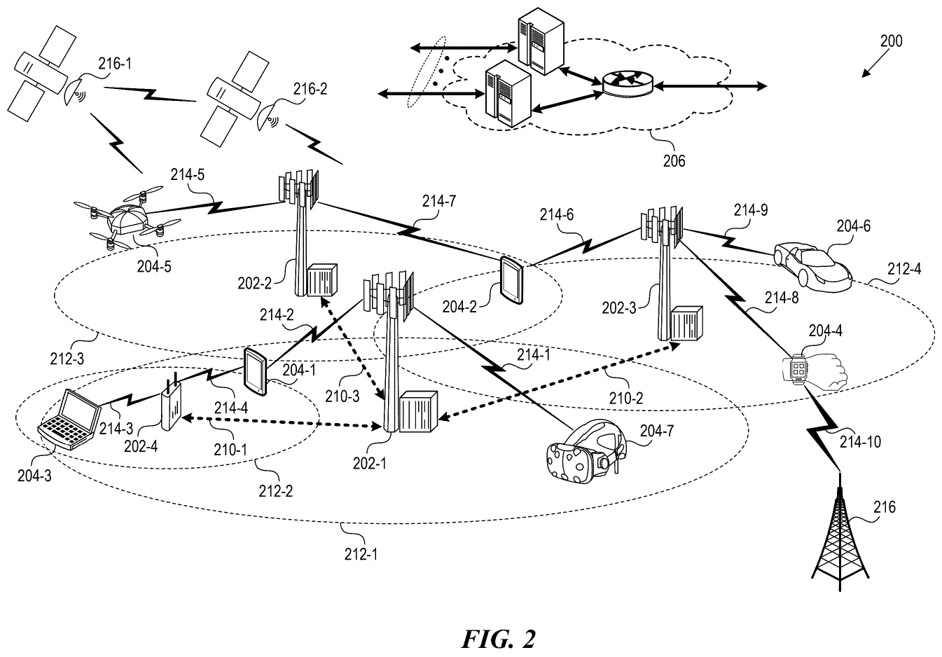

FIG. 2 is a block diagram that illustrates a wireless telecommunication network 200 (“network 200”) in which aspects of the disclosed technology are incorporated. For example, the network 200 is configured to enable RCS communication for its subscribers. The network 200 includes base stations 202-2 through 202-4 (also referred to individually as “base station 202” or collectively as “base stations 202”). A base station is a type of network access node (NAN) that can also be referred to as a cell site, a base transceiver station, or a radio base station. The network 200 can include any combination of NANs including an access point, radio transceiver, gNodeB (gNB), NodeB, eNodeB (eNB), Home NodeB or Home eNodeB, or the like. In addition to being a wireless wide area network (WWAN) base station, a NAN can be a wireless local area network (WLAN) access point, such as an Institute of Electrical and Electronics Engineers (IEEE) 802.21 access point.

The NANs of a network 200 formed by the network 200 also include wireless devices 204-2 through 204-7 (referred to individually as “wireless device 204” or collectively as “wireless devices 204”) and a core network 206. The wireless devices 204 can correspond to or include network 200 entities capable of communication using various connectivity standards. For example, a 5G communication channel can use millimeter wave (mmW) access frequencies of 28 GHz or more. In some implementations, the wireless device 204 can operatively couple to a base station 202 over a long-term evolution/long-term evolution-advanced (LTE/LTE-A) communication channel, which is referred to as a 4G communication channel.

The core network 206 provides, manages, and controls security services, user authentication, access authorization, tracking, internet protocol (IP) connectivity (e.g., for RCS messaging), and other access, routing, or mobility functions. The base stations 202 interface with the core network 206 through a first set of backhaul links (e.g., S1 interfaces) and can perform radio configuration and scheduling for communication with the wireless devices 204 or can operate under the control of a base station controller (not shown). In some examples, the base stations 202 can communicate with each other, either directly or indirectly (e.g., through the core network 206), over a second set of backhaul links 210-2 through 210-3 (e.g., X1 interfaces), which can be wired or wireless communication links.

The base stations 202 can wirelessly communicate with the wireless devices 204 via one or more base station antennas. The cell sites can provide communication coverage for geographic coverage areas 212-2 through 212-4 (also referred to individually as “coverage area 212” or collectively as “coverage areas 212”). The coverage area 212 for a base station 202 can be divided into sectors making up only a portion of the coverage area (not shown). The network 200 can include base stations of different types (e.g., macro and/or small cell base stations). In some implementations, there can be overlapping coverage areas 212 for different service environments (e.g., Internet of Things (IoT), mobile broadband (MBB), vehicle-to-everything (V2X), machine-to-machine (M2M), machine-to-everything (M2X), ultra-reliable low-latency communication (URLLC), machine-type communication (MTC), etc.).

The network 200 can include a 5G network 200 and/or an LTE/LTE-A or other network. In an LTE/LTE-A network, the term “eNBs” is used to describe the base stations 202, and in 5G new radio (NR) networks, the term “gNBs” is used to describe the base stations 202 that can include mmW communications. The network 200 can thus form a heterogeneous network 200 in which different types of base stations provide coverage for various geographic regions. For example, each base station 202 can provide communication coverage for a macro cell, a small cell, and/or other types of cells. As used herein, the term “cell” can relate to a base station, a carrier or component carrier associated with the base station, or a coverage area (e.g., sector) of a carrier or base station, depending on context.

A macro cell generally covers a relatively large geographic area (e.g., several kilometers in radius) and can allow access by wireless devices that have service subscriptions with a wireless network 200 service provider. As indicated earlier, a small cell is a lower-powered base station, as compared to a macro cell, and can operate in the same or different (e.g., licensed, unlicensed) frequency bands as macro cells. Examples of small cells include pico cells, femto cells, and micro cells. In general, a pico cell can cover a relatively smaller geographic area and can allow unrestricted access by wireless devices that have service subscriptions with the network 200 provider. A femto cell covers a relatively smaller geographic area (e.g., a home) and can provide restricted access by wireless devices having an association with the femto unit (e.g., wireless devices in a closed subscriber group (CSG), wireless devices for users in the home). A base station can support one or multiple (e.g., two, three, four, and the like) cells (e.g., component carriers). All fixed transceivers noted herein that can provide access to the network 200 are NANs, including small cells.

The communication networks that accommodate various disclosed examples can be packet-based networks that operate according to a layered protocol stack. In the user plane, communications at the bearer or Packet Data Convergence Protocol (PDCP) layer can be IP-based. A Radio Link Control (RLC) layer then performs packet segmentation and reassembly to communicate over logical channels. A Medium Access Control (MAC) layer can perform priority handling and multiplexing of logical channels into transport channels. The MAC layer can also use Hybrid ARQ (HARQ) to provide retransmission at the MAC layer, to improve link efficiency. In the control plane, the Radio Resource Control (RRC) protocol layer provides establishment, configuration, and maintenance of an RRC connection between a wireless device 204 and the base stations 202 or core network 206 supporting radio bearers for the user plane data. At the Physical (PHY) layer, the transport channels are mapped to physical channels.

Wireless devices can be integrated with or embedded in other devices. As illustrated, the wireless devices 204 are distributed throughout the network 200, where each wireless device 204 can be stationary or mobile. For example, wireless devices can include handheld mobile devices 204-2 and 204-2 (e.g., smartphones, portable hotspots, tablets, etc.); laptops 204-3; wearables 204-4; drones 204-5; vehicles with wireless connectivity 204-6; head-mounted displays with wireless augmented reality/virtual reality (AR/VR) connectivity 204-7; portable gaming consoles; wireless routers, gateways, modems, and other fixed-wireless access devices; wirelessly connected sensors that provide data to a remote server over a network; IoT devices such as wirelessly connected smart home appliances; etc.

A wireless device (e.g., wireless devices 204) can be referred to as a user equipment (UE), a customer premises equipment (CPE), a mobile station, a subscriber station, a mobile unit, a subscriber unit, a wireless unit, a remote unit, a handheld mobile device, a remote device, a mobile subscriber station, a terminal equipment, an access terminal, a mobile terminal, a wireless terminal, a remote terminal, a handset, a mobile client, a client, or the like.

A wireless device can communicate with various types of base stations and network 200 equipment at the edge of a network 200 including macro eNBs/gNBs, small cell eNBs/gNBs, relay base stations, and the like. A wireless device can also communicate with other wireless devices either within or outside the same coverage area of a base station via device-to-device (D2D) communications.

The communication links 214-2 through 214-9 (also referred to individually as “communication link 214” or collectively as “communication links 214”) shown in network 200 include uplink (UL) transmissions from a wireless device 204 to a base station 202 and/or downlink (DL) transmissions from a base station 202 to a wireless device 204. The downlink transmissions can also be called forward link transmissions while the uplink transmissions can also be called reverse link transmissions. Each communication link 214 includes one or more carriers, where each carrier can be a signal composed of multiple sub-carriers (e.g., waveform signals of different frequencies) modulated according to the various radio technologies. Each modulated signal can be sent on a different sub-carrier and carry control information (e.g., reference signals, control channels), overhead information, user data, etc. The communication links 214 can transmit bidirectional communications using frequency division duplex (FDD) (e.g., using paired spectrum resources) or time division duplex (TDD) operation (e.g., using unpaired spectrum resources). In some implementations, the communication links 214 include LTE and/or mmW communication links.

In some implementations of the network 200, the base stations 202 and/or the wireless devices 204 include multiple antennas for employing antenna diversity schemes to improve communication quality and reliability between base stations 202 and wireless devices 204. Additionally or alternatively, the base stations 202 and/or the wireless devices 204 can employ multiple-input, multiple-output (MIMO) techniques that can take advantage of multi-path environments to transmit multiple spatial layers carrying the same or different coded data.

In some examples, the network 200 implements 6G technologies including increased densification or diversification of network nodes. The network 200 can enable terrestrial and non-terrestrial transmissions. In this context, a Non-Terrestrial Network (NTN) is enabled by one or more satellites, such as satellites 216-2 and 216-2, to deliver services anywhere and anytime and provide coverage in areas that are unreachable by any conventional Terrestrial Network (TN). A 6G implementation of the network 200 can support terahertz (THz) communications. This can support wireless applications that demand ultrahigh quality of service (QoS) requirements and multi-terabits-per-second data transmission in the era of 6G and beyond, such as terabit-per-second backhaul systems, ultra-high-definition content streaming among mobile devices, AR/VR, and wireless high-bandwidth secure communications. In another example of 6G, the network 200 can implement a converged Radio Access Network (RAN) and Core architecture to achieve Control and User Plane Separation (CUPS) and achieve extremely low user plane latency. In yet another example of 6G, the network 200 can implement a converged Wi-Fi and Core architecture to increase and improve indoor coverage.

### Example Implementations of 5G Core Network Functions

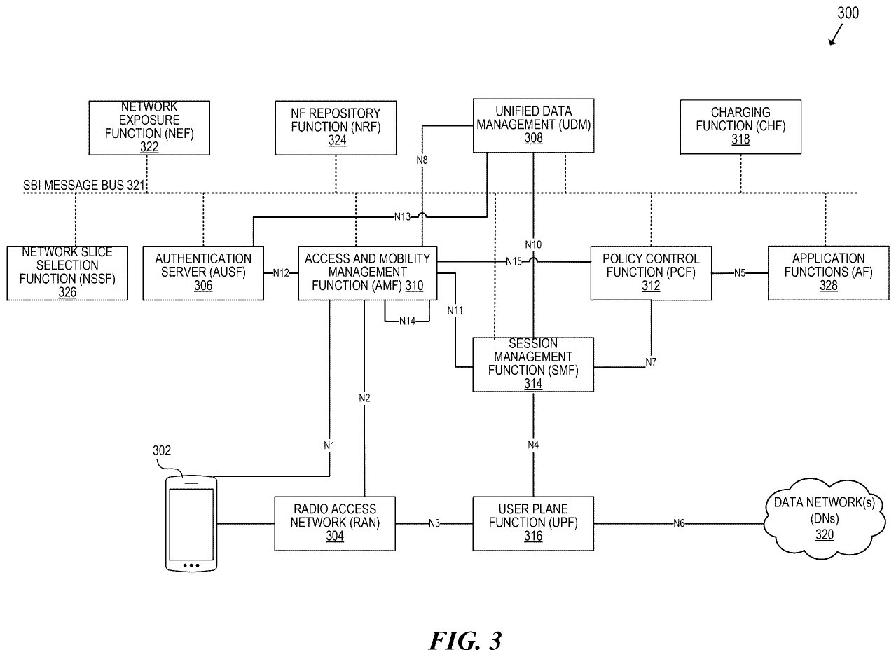

FIG. 3 is a block diagram that illustrates an architecture 300 including 5G core network functions (NFs) that can implement aspects of the present technology. A wireless device 302 can access the 5G network through a NAN (e.g., gNB) of a RAN 304. The NFs include an Authentication Server Function (AUSF) 306, a Unified Data Management (UDM) 308, an Access and Mobility management Function (AMF) 310, a Policy Control Function (PCF) 312, a Session Management Function (SMF) 314, a User Plane Function (UPF) 316, and a Charging Function (CHF) 318.

The interfaces N1 through N15 define communications and/or protocols between each NF as described in relevant standards. The UPF 316 is part of the user plane and the AMF 310, SMF 314, PCF 312, AUSF 306, and UDM 308 are part of the control plane. One or more UPFs can connect with one or more data networks (DNs) 320. The UPF 316 can be deployed separately from control plane functions. The NFs of the control plane are modularized such that they can be scaled independently. As shown, each NF service exposes its functionality in a Service Based Architecture (SBA) through a Service Based Interface (SBI) 321 that uses HTTP/3. The SBA can include a Network Exposure Function (NEF) 322, an NF Repository Function (NRF) 324, a Network Slice Selection Function (NSSF) 326, and other functions such as a Service Communication Proxy (SCP).

The SBA can provide a complete service mesh with service discovery, load balancing, encryption, authentication, and authorization for interservice communications. The SBA employs a centralized discovery framework that leverages the NRF 324, which maintains a record of available NF instances and supported services. The NRF 324 allows other NF instances to subscribe and be notified of registrations from NF instances of a given type. The NRF 324 supports service discovery by receipt of discovery requests from NF instances and, in response, details which NF instances support specific services.

The NSSF 326 enables network slicing, which is a capability of 5G to bring a high degree of deployment flexibility and efficient resource utilization when deploying diverse network services and applications. A logical end-to-end (E2E) network slice has pre-determined capabilities, traffic characteristics, and service-level agreements and includes the virtualized resources required to service the needs of a Mobile Virtual Network Operator (MVNO) or group of subscribers, including a dedicated UPF, SMF, and PCF. The wireless device 302 is associated with one or more network slices, which all use the same AMF. A Single Network Slice Selection Assistance Information (S-NSSAI) function operates to identify a network slice. Slice selection is triggered by the AMF, which receives a wireless device registration request. In response, the AMF retrieves permitted network slices from the UDM 308 and then requests an appropriate network slice of the NSSF 326.

The UDM 308 introduces a User Data Convergence (UDC) that separates a User Data Repository (UDR) for storing and managing subscriber information. As such, the UDM 308 can employ the UDC under 3GPP TS 32.101 to support a layered architecture that separates user data from application logic. The UDM 308 can include a stateful message store to hold information in local memory or can be stateless and store information externally in a database of the UDR. The stored data can include profile data for subscribers and/or other data that can be used for authentication purposes. Given a large number of wireless devices that can connect to a 5G network, the UDM 308 can contain voluminous amounts of data that is accessed for authentication. Thus, the UDM 308 is analogous to a Home Subscriber Server (HSS) and can provide authentication credentials while being employed by the AMF 310 and SMF 314 to retrieve subscriber data and context.

The PCF 312 can connect with one or more Application Functions (AFs) 328. The PCF 312 supports a unified policy framework within the 5G infrastructure for governing network behavior. The PCF 312 accesses the subscription information required to make policy decisions from the UDM 308 and then provides the appropriate policy rules to the control plane functions so that they can enforce them. The SCP (not shown) provides a highly distributed multi-access edge compute cloud environment and a single point of entry for a cluster of NFs once they have been successfully discovered by the NRF 324. This allows the SCP to become the delegated discovery point in a datacenter, offloading the NRF 324 from distributed service meshes that make up a network operator's infrastructure. Together with the NRF 324, the SCP forms the hierarchical 5G service mesh.

The AMF 310 receives requests and handles connection and mobility management while forwarding session management requirements over the N11 interface to the SMF 314. The AMF 310 determines that the SMF 314 is best suited to handle the connection request by querying the NRF 324. That interface and the N11 interface between the AMF 310 and the SMF 314 assigned by the NRF 324 use the SBI 321. During session establishment or modification, the SMF 314 also interacts with the PCF 312 over the N7 interface and the subscriber profile information stored within the UDM 308. Employing the SBI 321, the PCF 312 provides the foundation of the policy framework that, along with the more typical QoS and charging rules, includes network slice selection, which is regulated by the NSSF 326.

### Example Implementations for Predicting RRC Establishment Cause Information

Example implementations disclosed herein relate to predictions of establishment cause information included in RRC messages received by a network from incoming UEs. In particular, a distribution of different enumerated establishment causes is predicted to thereby enable proactive cell site operations based thereon, and the predictions are provided via ML implementations at a network cell site to therefore enable prediction specificity and real-time performance. These predictions can be applied in cell site operations including access class barring (ACB), dynamic resource pool allocation, and preemptive offloading.

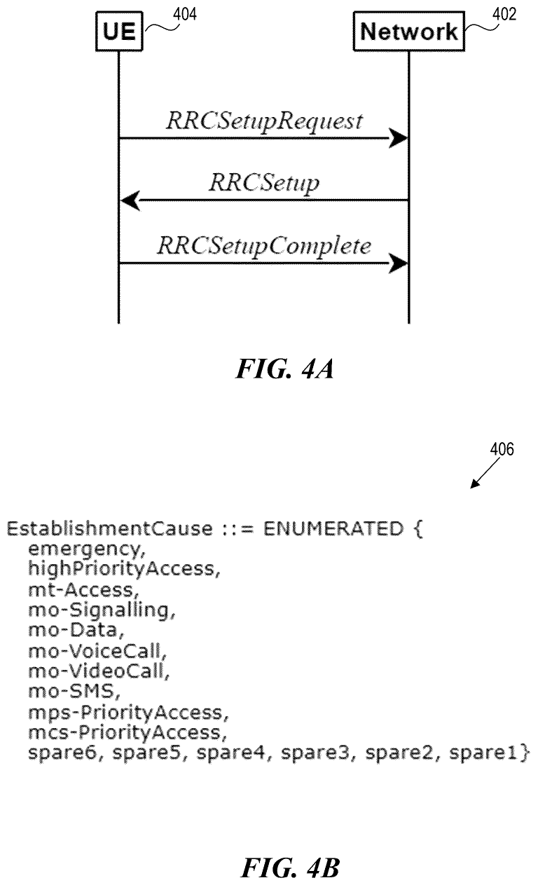

FIGS. 4A and 4B illustrate examples of RRC signalling and establishment cause information included in said signalling. In FIG. 4A, a network node 402 receives a new RRC setup request or message from a wireless device 404 (e.g., a UE) that seeks to establish a session on a telecommunications network. After receiving the RRC setup request from the wireless device 404, the network node 402 may generally configure a RRC session that handles or manages the wireless device's connection with the telecommunications network (and particularly with the RAN). According to some implementations, the network node 402 may determine that it cannot initiate a RRC session for the wireless device 404 at its cell site and may decline the RRC setup request. Otherwise, the network node 402 initiates the RRC session, and the network node 402 and the wireless device 404 engage in further signalling (e.g., “RRCSetup” and “RRCSetupComplete”) to complete the session setup process. Some implementations of the present disclosure may implement protocols defined in 3^{rd} Generation Partnership Project (3GPP) Technical Specification TS 38.331 for establishing and handling RRC connections between a network node 402 and a wireless device 404.

When configuring and initiating an RRC session for the wireless device 404 at the node's cell site, the network node 402 uses information included in the RRC setup request received from the wireless device 404. According to example implementations, the RRC setup request includes establishment cause information 406, examples of which being demonstrated in FIG. 4B. Establishment cause information 406 can generally indicate a reason or purpose for which the wireless device 404 is requesting connection to the network, and the reason/purpose indicated by establishment cause information 406 can correspond to various user services or actions at the wireless device 404. For example, example establishment causes are shown in FIG. 4B and include:

Emergency: This cause is used for emergency calls, allowing UEs to gain immediate network access with the highest priority to ensure rapid response in critical situations.

HighPriorityAccess: This establishment cause is for services that require higher priority but are not necessarily emergency-level. It is often used for important but non-life-threatening communications.

MT-Access (Mobile Terminated Access): This refers to connections initiated by the network towards the UE, typically for incoming calls or data sessions.

MO-Signalling (Mobile Originated Signalling): Used when the UE needs to send signaling data to the network, such as registration, keep-alive signals, or small data transmissions that keep the UE connected and reachable.

MO-Data (Mobile Originated Data): This cause is used when the UE initiates a data session for transmitting data packets, such as internet browsing or app data.

MO-VoiceCall: Used specifically when the UE initiates a traditional voice call.

MO-VideoCall: Similar to MO-VoiceCall but specifically for initiating video calls, which typically require higher bandwidth and prioritization.

MO-SMS (Mobile Originated Short Message Service): This cause is used when sending SMS messages from the UE to the network.

MPS-PriorityAccess (Mission-Critical Push-To-Talk Service Priority Access): A specialized cause used for mission-critical services, often in public safety scenarios where users need guaranteed network resources for push-to-talk services.

MCS-PriorityAccess (Mission-Critical Service Priority Access): Like MPS, but used for broader mission-critical communications, which may include video, data, or voice services that require high reliability and prioritization.

Establishment causes are particularly defined and configured for the telecommunications network. Wireless devices 404 configured to subscribe to the telecommunications network can use an establishment cause schema or enumeration that the telecommunications network defines. In other example implementations, a telecommunications network can define other establishment causes alternative to the examples shown in FIG. 4B, such as:

Location Services: A request to access location-based services, such as GPS or other positioning services.

Internet of Things (IoT) Communication: A request from IoT devices for various types of connectivity, ranging from low-power sensors to high-bandwidth industrial equipment.

The establishment cause information is used by the network node 402 to determine the appropriate handling and prioritization of the RRC connection request. In some implementations, the network node 402 may allocate certain pools of radio resources to different establishment causes, and accordingly, the RRC session it initiates for the wireless device 404 can be configured with radio resources from a resource pool corresponding to the establishment cause that the wireless device 404 indicated. The network node 402 can further apply quality of service (QoS) parameters (e.g., 5QI or 5G QoS Identifier, QCI or 4G QoS Class Identifier) and manage the active RRC session based on the establishment cause indicated during setup. Application of QoS parameters uses the establishment cause as context and may be further based on additional information. For example, the network node 402 may assign a higher or lower QoS parameter to the RRC session based on the wireless device's device model (e.g., iPhone™, Android™), whether the wireless device is roaming on the network, and/or the like.

The establishment cause initially indicated to setup an active RRC session remains relevant during the course of the active RRC session. While RRC reconfiguration signalling may be performed between the network node 402 and the wireless device 404 to accommodate additional operations (e.g., data browsing after/during an emergency call, SMS message sending after/during a video call), the establishment cause can continue being used for at least the initial radio bearer for the first operation for which the RRC session was requested.

Cell-wide operations or node-centered operations can also benefit from the establishment cause information included in RRC setup messages received by a network node. That is, in addition to configuring a RRC session with radio resources based on the establishment cause, example implementations of network node can use establishment cause information for access class barring, as demonstrated with FIG. 1. Access Class Barring (ACB) is used to manage and control the overload situations. This technique is primarily implemented to prevent network congestion by temporarily restricting access to network resources for certain types of traffic or users during peak times or in specific scenarios, such as emergencies, and these traffic/user types can be determined from establishment cause information. Thus, a network node can determine whether to accept or decline a RRC setup request based on the establishment cause information included in the RRC setup request and further based on the establishment causes associated with existing RRC sessions at the network node. Thus, a network node may start rejecting new incoming users with lower priority establishment causes during overload scenarios to accommodate high priority or emergency users. Those new incoming users get rejected during ‘ACB Active’ stage till ‘ACB Inactive’ stage shown on x-axis. However, the rejection of these new incoming users causes degraded experience when they experience delays to get service by re-attempting to same cell or another cell.

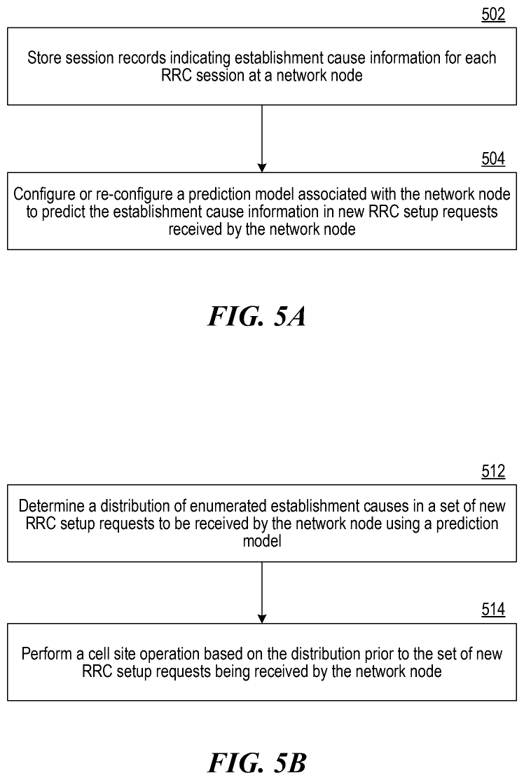

FIG. 5A illustrates example operations for embedding establishment cause predictions at a network node in order to proactively perform cell site operations. The example operations illustrated in FIG. 5A can be performed in some implementations to embed establishment cause prediction capability at network nodes of a RAN.

At 502, a network node stores session records indicating establishment cause information for each RRC session at the network node. In some implementations, the session records are location session records (LSRs). The session records may be stored at a record database included in the radio access network. In some examples, the RAN is configured as an Open RAN, and a record database storing the session records may be distributed across the RAN.

The session records include the establishment cause that was indicated for each of the RRC sessions at the network node. The session records can include additional information, including: make and model of the terminal/UE transmitting the RRC setup request; service type of the RRC session (e.g., data only, voice and data, voice only); security information (e.g., an international mobile subscriber identity (IMSI), a temporary mobile subscriber identity (e.g., TMSI, m-TMSI)); time information for the session (e.g., start time, end time, duration) end type for the session (e.g., outgoing X2 handover, intra-eNB handover) and final disposition (e.g., outgoing handover, dropped connection, normal release, failed attempt); start cell and end cell (and corresponding RAN node identifiers); signal quality information (e.g., reference signal received power (RSRP) [dBm], reference signal received quality (RSRQ) [dB]); End Timing Advance [Miles]; Intra-frequency Intra-eNB handover (HO) Attempts; Intra-frequency Intra-eNB HO Failures; Inter-frequency Intra-eNB HO Attempts; Inter-frequency Intra-eNB HO Failures; Intra-frequency X2 HO Prep Attempts; Intra-frequency X2 HO Prep Failures; Intra-frequency X2 HO Exec Failures; Inter-frequency X2 HO Prep Attempts; Inter-frequency X2 HO Prep Failures; Inter-frequency X2 HO Exec Failures; Intra-frequency S1 HO Prep Attempts; Intra-frequency S1 HO Prep Failures; Intra-frequency S1 HO Exec Failures; Inter-frequency S1 HO Prep Attempts; Inter-frequency S1 HO Prep Failures; Inter-frequency S1 HO Exec Failures; inter-radio access technology (IRAT) HO Attempts; Last VoLTE eRAB Start Time; Last VoLTE eRAB End Time; Last VoLTE eRAB Duration; Last VoLTE eRAB Release Cause; VoLTE eRABs with Emergency ARP; Initial NAS Request; Initial NAS Response; OEM RRC Setup Cause; OEM S1 Setup Cause; OEM S1 Release Cause; OEM Internal Release Cause; Release with Data Lost; Data Lost; Mean channel quality indicator (CQI); medium access control (MAC) Volume DL [bytes]; MAC Volume UL [bytes]; packet data convergence protocol (PDCP) Volume DL [bytes]; PDCP Volume UL [bytes]; Mean PDCP data radio bearer (DRB) Throughput DL [kbps]; Mean PDCP DRB Throughput UL [kbps]; Average Number of LTE Carrier Components, and/or the like.

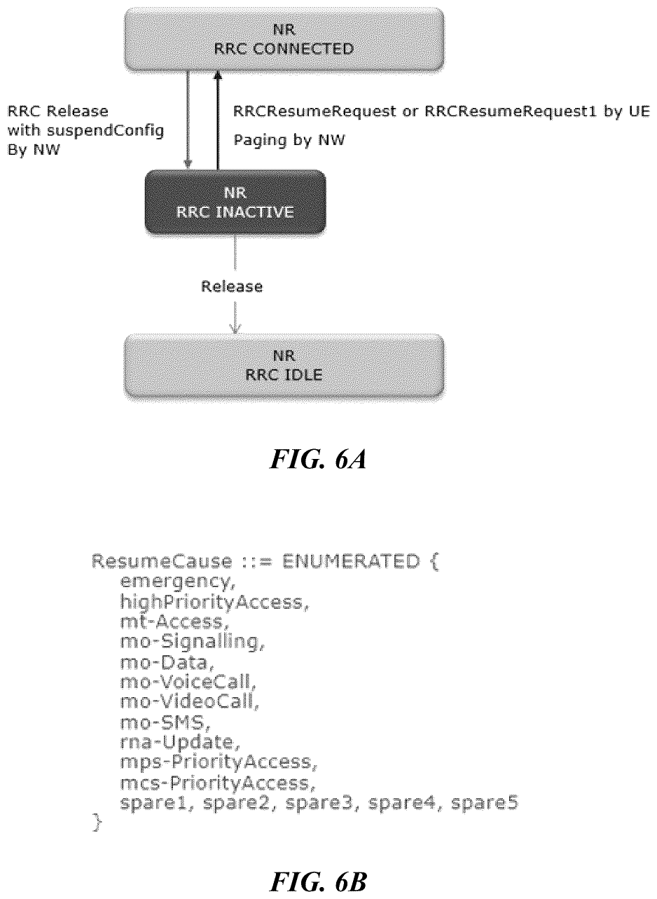

In some examples, a session record is stored for each active session at the network node. In some implementations, a session record continues to be stored for RRC sessions that have become inactive. As illustrated in FIG. 6A, a RAN may be configured to allow radio resource configurations to have different states including active, inactive, and idle. An inactive state for a radio resource configuration may be a temporary state based on an expectation or prediction that the radio resource configuration will transition back to the active state soon. Thus, transitioning a radio resource configuration from active (or connected) to inactive may not release the configured resources. As depicted in FIG. 6B, an inactive RRC may transition back to an active or connected state, and in doing so, a resume cause may be indicated. The resume cause may be one of an enumerated set of causes, and the enumerated set of causes from which the resume cause is selected may be the same as the enumerated set for the establishment cause. In some implementations, the session records stored for RRC sessions at the network node can be updated to include resume causes, in addition to the original establishment cause for the session.

At 504, the network node configures or re-configures a prediction model associated with the network node to predict the establishment cause information in new RRC setup requests received by the network node. In some implementations, the prediction model is specific to the network node and is trained to predict a distribution of establishment causes in RRC setup requests received specifically at the network node. In this aspect, the prediction model can control for location differences among different cell sites. The prediction model is trained or re-trained to predict establishment cause information based on the session records stored for RRC sessions at the network node. In particular, the prediction model is trained or re-trained based on the establishment causes (and resume causes, in some implementations) included in the session records. Thus, in some implementations, a training dataset and/or validation dataset for the prediction model can be generated using the establishment cause information included in the session records. In some implementations, the prediction model includes one or more of a gradient boosting machine, a weighted ensemble, or a random forest.

According to example implementations, the prediction model is configured to output a predicted distribution of enumerated establishment causes for an upcoming time period. In some examples, the prediction model predicts a number of incoming RRC setup requests for a given establishment cause, and repeats the prediction for each of the enumerated set of establishment causes. In some examples, the prediction model predicts proportions of an incoming number of RRC setup requests allocated to each of the establishment causes, and thus, the prediction for each establishment cause may be related or dependent on the prediction for other establishment causes. In some examples, the prediction model predicts a ratio of one or more high-priority establishment causes (or establishment causes that cause a RRC session to be configured with high priority) to one or more low-priority establishment causes (or establishment causes that do not cause a RRC session to be configured with high priority).

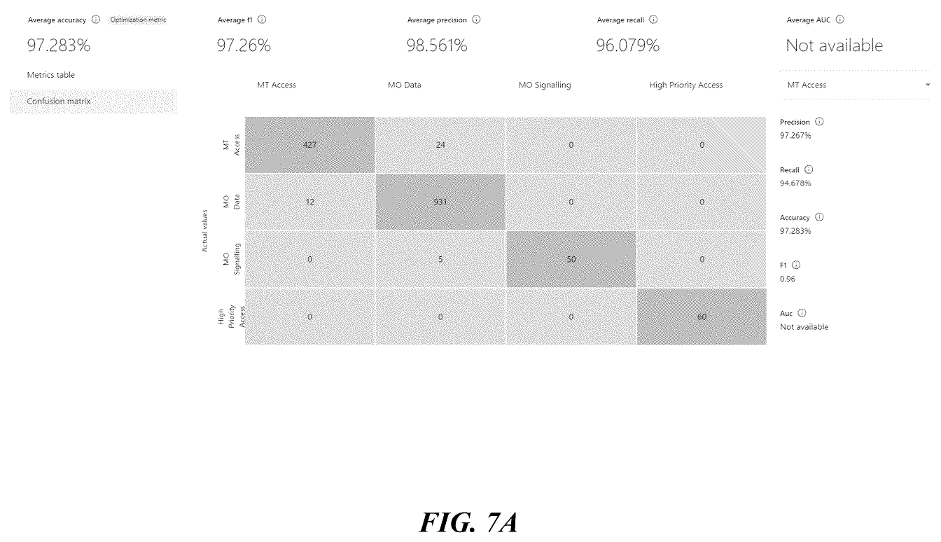

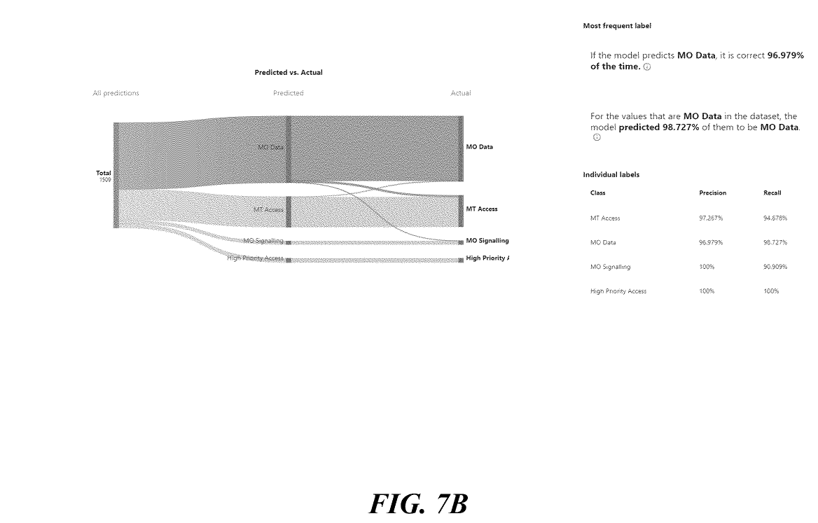

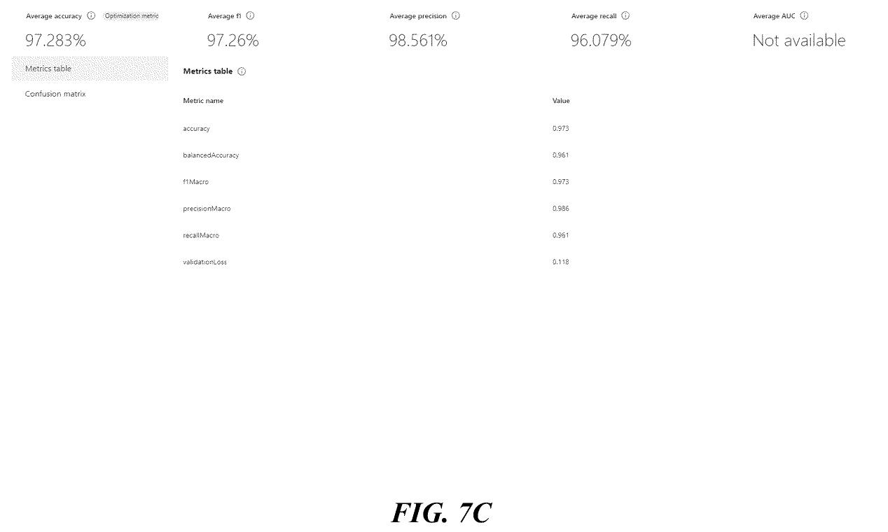

FIGS. 7A-7C illustrate example outputs that the prediction model is configured to generate based on being trained on the session records for RRC sessions of the network node, in some implementations. In FIGS. 7A and 7B, the predicted number of setup requests with one of the enumerated establishment causes (MT access, MO data, MO signalling, high priority access)) as determined by the prediction model are evaluated against an actual number of setup requests per establishment cause. This evaluation and similar evaluations can be used to re-train or re-configure the prediction model to improve the predictions. In particular, the actual number of setup requests per establishment cause can be identified from the session records stored in the RAN. As shown in FIGS. 7A-7B, configuration and training of the prediction model may result in different accuracies for different ones of the enumerated establishment causes. For example, the prediction model in the illustrated embodiment achieves 100% precision and 100% recall for predicting the number or proportion of high priority access establishment cause in upcoming RRC setup requests, but only achieves 90.909% recall for predicting the MO signalling establishment cause.

In some implementations, the predicted model may be configured or trained to optimize accuracy or other performance metrics (e.g., specificity, precision, recall) for one or more of the set of enumerated establishment causes, as shown in FIG. 7C. For example, the predicted model may be optimized for predicting the high priority access establishment cause, which may be more important for the network node to be accurately aware of to handle resource allocation and configurations (compared to MO signalling establishment cause). In some implementations, the one or more of the set of enumerated establishment causes that the predicted model prioritizes in training may differ for different network nodes. For example, a network node in an area associated with frequent emergency response deployments may have its prediction model more tuned for accurately predicting the high priority access establishment cause (sacrificing some accuracy/performance for other establishment causes), while a network node in a congested area may have its corresponding prediction model more tuned for accurately predicting the MO signalling establishment cause (to better predict handovers). Thus, rather than optimizing average metrics such as those shown in FIG. 7C, the predicted model may be trained and re-trained to optimize metrics specific to one or more of the establishment causes.

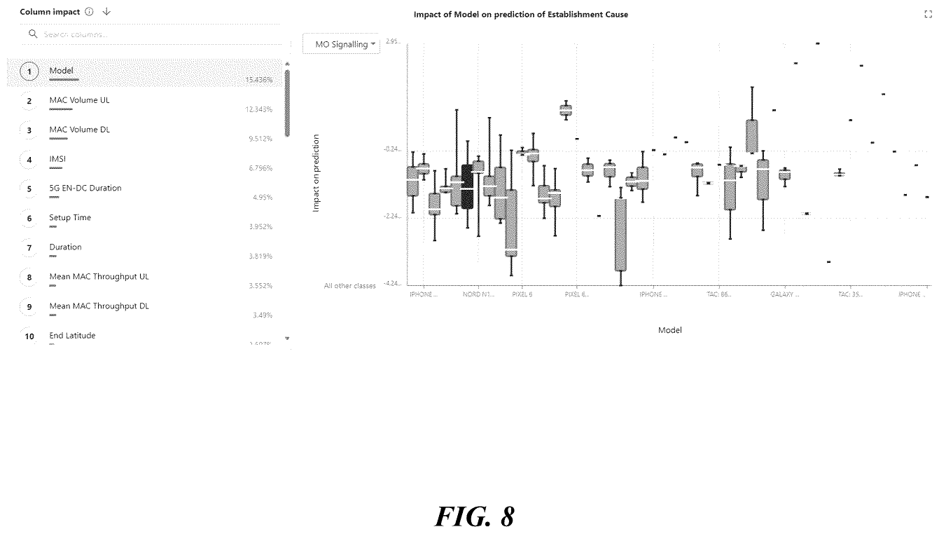

Configuring the predicted model may include modifying weights associated with different features included in the session records used to train the prediction model. The weights may be modified automatically via machine learning techniques, and/or specifically based on desired results and/or domain knowledge. FIG. 8 illustrates example data depicting the impact of certain features included in the session records on the establishment cause prediction generated by the predicted model. In the illustrated example, the model of the terminal/UE requested RRC setup has a relatively larger (˜15%) impact on the prediction of the MO signalling establishment cause. This may occur due to different device models having different predefined criteria that control how a given terminal/UE selects a particular establishment cause in its RRC setup request, and generally, different device models tend to exhibit distinct usage patterns, behaviors, and service capabilities. For example, an Android™ UE may more frequently select a lower priority establishment cause for text messages (e.g., MO-SMS), compared to an iPhone™ UE that more frequently selects a higher priority establishment cause for text messages (e.g., MO-Data). As a further example, iPhone™ UEs may more frequently make more video calls compared to Android™ UE, due to model-specific applications like FaceTime™ providing video call functionality. As an even further example, high-end devices may be more likely to initiate data-heavy applications (e.g., video streaming, extended/augmented/virtual reality) compared to budget devices that might prioritize lighter data services or voice calls and also Internet-of-Traffic (IoT) devices like (narrowband) NB-IoT can only do SMS or small data sessions. Or, a same device model in a prepaid plan can be assigned to use a high priority QoS while the same model used by a roaming user can be confined to a lower priority QoS. Accordingly, the prediction model may be re-configured to increase the weight associated with the device model as an input feature, in order to capture these relationships and behaviors.

In some implementations, the prediction model, or at least a portion thereof, is deployed within the operational framework of the RAN. For example, prediction models for one or more network nodes can reside on a cell site database or other RAN infrastructure that is communicably coupled to the one or more network nodes that are located nearby. In some implementations, a prediction model for a network node can reside on the baseband processing unit of a network node to run real-time data processing with customized predictions granular to specific cell-level. Thus, a network node is able to generate an inference using at least a portion of the prediction model that is deployed in its own processing unit, and in some implementations, communications from the network node to another server (e.g., an application server, a server associated with RAN operations, a third-party server) are minimized based on execution of the prediction locally at the network node. Certain modules, layers, processing blocks, and/or the like may be deployed locally at a network node, with other portions being deployed elsewhere in the RAN based on various trade-offs. For example, if (1) lightweight processing and node specific data handling is preferred (macro vs small cells based on their deployment) or (2) private network setup to be supported with data sensitivity or (3) latency sensitive implementation is desired with quick adaptation for real time users-local node implementation may be preferred. On the other hand, if operators choose to train using large data sets that covers all types of users/scenarios with a complex processing and aggregated data centrally, a remote/cloud approach can be adopted. In some implementations, a hybrid approach could be used, such that the large scale training can be done remotely and the local node models can be updated periodically to adopt and evolve.

In some implementations, the RAN is an Open RAN, and multiple prediction models corresponding to multiple network nodes can be distributed across the multiple network nodes. In an Open RAN scenario, additional implementations and enhancements become available for deploying prediction models due to the decoupled and flexible architecture of Open RAN. For example, Near-Real-Time Radio Intelligent Controller (RIC) allows for real-time and near-real-time decisions based on predictions by leveraging xApps. non-real-time RIC can be used for longer-term predictions and optimizations, hosting rApps for network-wide training, model retraining, and policy generation. gNB components such as the distributed unit (DU) & centralized unit (CU) are disaggregated, allowing cloud-native deployment of certain ML model components. For example, prediction models for non-latency-sensitive tasks can be deployed in the CUs running in cloud infrastructure.

FIG. 5B illustrates example operations for using establishment cause predictions at a network node in order to proactively perform cell site operations. The example operations illustrated in FIG. 5B can be performed using prediction models embedded within a RAN to provide enhanced capabilities at individual network nodes of the RAN.

At 512, a network node determines a distribution of enumerated establishment causes in a set of new RRC setup requests to be received by the network node using a prediction model. In some implementations, the network node determines upcoming establishment causes using the prediction model on a periodic basis, which may be based on peak and off-peak times. For example, during the off-peak times in a day, the network node may determine upcoming establishment causes for an upcoming peak traffic time period, for the next day, and/or the like.

In some implementations, the network node may first determine a number of the new RRC setup requests that the network node expects to receive in an upcoming time period, as well as features associated with the new RRC setup requests. For example, the network node may first obtain a prediction (e.g., using one or more other prediction models) that the network node will receive a particular number of RRC setup requests in an upcoming time period, so that the network node can use the prediction model to predict the proportion of the particular number having each of the enumerated establishment causes. The network node may also obtain predictions for the input features of the expected RRC setup requests in an upcoming time period. For example, because device model may be an input feature for the prediction model, the network node may first obtain a prediction of how many of certain device models will be involved in the expected RRC setup requests. In some implementations, the network node can predict upcoming RRC setup requests by leveraging historical data, real-time monitoring of connected or idle devices, and mobility patterns. Before RRC requests occur, the node gathers information from previous device activity, location updates, and periodic attachments. By analyzing trends in device behavior, including application and network slice usage, the network can infer which device models are likely to initiate RRC setup soon, for example, allowing for proactive resource optimization and enhanced network performance.

At 514, the network node performs a cell site operation based on the predicted distribution prior to the set of new RRC setup requests being received by the network node. Because the RRC setup requests have not been received yet, the cell site operation is preemptive. In some implementations, the cell site operation includes offloading RRC sessions to other network nodes. In contrast to existing systems which cause handover between cell sites in reaction to signal quality metrics, example implementations can preemptively cause handover of an active RRC session to another cell site or network node, based on expected load on the network node. In some implementations, a network node may handover RRC sessions associated with high-priority establishment causes to another network node based on the network node predicting that it will receive a number of RRC setup requests having the same high-priority establishment cause or establishment causes with higher priority.

In some implementations, the cell site operation includes preemptively or proactively modifying radio resource distributions among different categories or groups of sessions. For example, a network node may assign pools of radio resources to different priorities of RRC sessions, which may be associated with the establishment causes for the RRC sessions. Accordingly, based on the prediction of establishment causes, the network node may dynamically modify or optimize the radio resource pools associated with the different RRC priorities. Thus, for example, the network node can anticipate an emergency dispatch for a special event based on first predicting a higher number of emergency or high priority establishment causes in RRC setup requests, and then adjusting radio resource allocations based on the prediction.

In some implementations, the cell site operation includes adjusting or modifying an access class barring (ACB) configuration. Under an ACB operation, a network node may determine whether to trigger an ACB state subsequent to new RRC sessions being set up. For example, the network node may receive a RRC setup request that indicates a particular establishment cause, and it may determine whether setting up the new RRC session based on the particular establishment cause results in a number of high-priority RRC sessions exceeding an ACB threshold. If the ACB threshold is exceeded, the network node may begin transitioning to an ACB state in which RRC setup requests with lower priority establishment causes are blocked or barred. The network node may perform such a responsive threshold check after new RRC setup requests are received and/or after releasing RRC sessions.

As shown in FIG. 1, the transition to an ACB state may span a start timer, or may be delayed after the threshold is exceeded due to uncertainty whether there will remain many high-priority RRC sessions. The ACB operation may similarly involve a stop timer. In some implementations, the ACB operation is modified based on the prediction of establishment causes for upcoming RRC setup requests. In a first example, the start timer (and/or the stop timer) is shortened or eliminated altogether, based on predictions that a number of high-priority RRC sessions will remain over the threshold (based on the predicted establishment causes). In another example, the threshold number of RRC sessions for triggering (or exiting) the ACB state may be adjusted to more sensitively trigger the ACB state, more resistantly trigger the ACB state, more sensitively exit the ACB state, or more resistantly exit the ACB state depending upon the predicted distribution of establishment causes. Again, adjusting of ACB operation parameters is also a preemptive operation because the RRC setup requests for which establishment causes are predicted have not occurred yet.

### Example Computer Systems

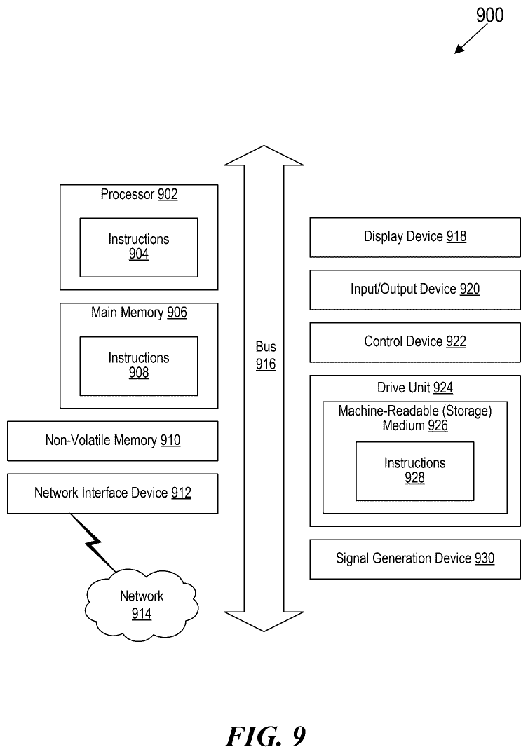

FIG. 9 is a block diagram that illustrates an example of a computer system 900 in which at least some operations described herein can be implemented. As shown, the computer system 900 can include: one or more processors 902, main memory 906, non-volatile memory 910, a network interface device 912, a video display device 918, an input/output device 920, a control device 922 (e.g., keyboard and pointing device), a drive unit 924 that includes a machine-readable (storage) medium 926, and a signal generation device 930 that are communicatively connected to a bus 916. The bus 916 represents one or more physical buses and/or point-to-point connections that are connected by appropriate bridges, adapters, or controllers. Various common components (e.g., cache memory) are omitted from FIG. 9 for brevity. Instead, the computer system 900 is intended to illustrate a hardware device on which components illustrated or described relative to the examples of the figures and any other components described in this specification can be implemented.

The computer system 900 can take any suitable physical form. For example, the computing system 900 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 900. In some implementations, the computer system 900 can be an embedded computer system, a system-on-chip (SOC), a single-board computer system (SBC), or a distributed system such as a mesh of computer systems, or it can include one or more cloud components in one or more networks. Where appropriate, one or more computer systems 900 can perform operations in real time, in near real time, or in batch mode.

The network interface device 912 enables the computing system 900 to mediate data in a network 914 with an entity that is external to the computing system 900 through any communication protocol supported by the computing system 900 and the external entity. Examples of the network interface device 912 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 906, non-volatile memory 910, machine-readable medium 926) can be local, remote, or distributed. Although shown as a single medium, the machine-readable medium 926 can include multiple media (e.g., a centralized/distributed database and/or associated caches and servers) that store one or more sets of instructions 928. The machine-readable medium 926 can include any medium that is capable of storing, encoding, or carrying a set of instructions for execution by the computing system 900. The machine-readable medium 926 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 910, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 904, 908, 928) set at various times in various memory and storage devices in computing device(s). When read and executed by the processor 902, the instruction(s) cause the computing system 900 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel, or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

1. A network node of a radio access network (RAN) of a telecommunications network, the network node comprising:
at least one hardware processor that is local to a cell site operated by the network node; and
at least one memory coupled to the at least one hardware processor, wherein the at least one memory stores instructions that, when executed by the at least one hardware processor, cause the network node to perform operations comprising:
receiving, from a wireless device, a radio resource configuration (RRC) setup request to initiate an active RRC session for the wireless device with the network node,
wherein the RRC setup request indicates a particular establishment cause that is one of a plurality of enumerated establishment causes defined for the telecommunications network;
in accordance with initiating the active RRC session for the wireless device with the network node, storing a location session record (LSR) associated with the active RRC session for the wireless device at a cell site database having a plurality of LSRs associated with active RRC sessions at the network node,
wherein each LSR associated with a given active RRC session comprises a corresponding establishment cause that was indicated to initiate the given active RRC session;
in response to the particular establishment cause being one of a subset of high-priority establishment causes within the plurality of enumerated establishment causes, determining whether to transition the cell site to an access class barring (ACB) state based on a number of the active sessions at the network node that are associated with the subset of high-priority establishment cause satisfying a ACB threshold;
providing, from the cell site database, the plurality of LSRs associated with the active RRC sessions at the network node to a local machine learning (ML) model to configure or re-configure the local ML model to predict a quantity of new RRC setup requests for each the plurality of enumerated establishment causes; and
subsequent to determining whether to transition the cell site to the ACB state, modifying the ACB threshold according to a priority ratio, the priority ratio comparing the quantity of new RRC setup requests for the subset of high-priority establishment causes predicted by the local ML model for an upcoming time period to the quantity predicted for a subset of remaining establishment causes.

2. The network node of claim 1, wherein the RRC setup request indicates the particular establishment cause based on predefined criteria specific to a device model of the wireless device, and wherein the plurality of LSRs stored at the cell site database each indicate a corresponding device model.

3. The network node of claim 1, wherein the operations further comprise:
prior to the upcoming time period, causing a handover of at least one active RRC session at the network node associated with the subset of high-priority establishment causes to a second cell site.

4. The network node of claim 1, wherein the cell site database is configured to continue storing a particular LSR associated with a particular active RRC session that has become inactive, and wherein the operations further comprise:
updating the particular LSR to include a resume cause that is one of a plurality of enumerated resume causes defined for the telecommunications network.

5. The network node of claim 1, wherein the local ML model comprises one or more of a gradient boosting machine, a weighted ensemble, or a random forest.

6. A non-transitory computer-readable storage medium storing instructions that, when executed by at least one hardware processor of a network node of a RAN of a telecommunications network, causes the network node to perform operations comprising:
in response to receiving a RRC setup request from a wireless device, initiating an active RRC session at the network node for the wireless device,
wherein the RRC setup request indicates a particular establishment cause that is one of a plurality of enumerated establishment causes defined for the telecommunications network,
wherein the active RRC session is initiated with radio resources allocated from a pre-defined resource pool associated with the particular establishment cause;
storing a plurality of session records at a cell site database, the plurality of session records recording an establishment cause for each of a plurality of active RRC sessions at the network node including the active RRC session initiated for the wireless device;
locally implementing a prediction model that is coupled to the cell site database,
wherein the prediction model is configured to use the plurality of session records stored at the cell site database to predict a quantity of new RRC setup requests indicating a given establishment cause and being received by the network node within an upcoming time period; and
prior to the upcoming time period, performing a cell site operation based at least on the quantity of new RRC setup requests predicted by the prediction model for a subset of high-priority establishment causes.

7. The non-transitory computer-readable storage medium of claim 6, wherein the cell site operation comprises modifying one or more quantity thresholds based on which the network node is configured to transition into or out of an access class barring (ACB) state in which the network node declines to initiate RRC sessions for RRC setup requests failing to indicate one of the subset of high-priority establishment causes.

8. The non-transitory computer-readable storage medium of claim 6, wherein the cell site operation comprises re-allocating the pre-defined resource pool associated with the particular establishment cause.

9. The non-transitory computer-readable storage medium of claim 6, wherein the cell site operation comprises offloading at least one active RRC session at the network node to a different cell site.

10. The non-transitory computer-readable storage medium of claim 6, wherein the plurality of session records further indicate a device model for each of the plurality of active RRC sessions.

11. The non-transitory computer-readable storage medium of claim 6, wherein a given session record is configured to record a resume cause for a given active RRC session that was previously in an inactive state.

12. The non-transitory computer-readable storage medium of claim 6, wherein the prediction model comprises one or more of a gradient boosting machine, a weighted ensemble, or a random forest.

13. A computer-implemented method comprising:
in response to receiving a RRC setup request from a wireless device, initiating an active RRC session at a network node of a RAN of a telecommunications network for the wireless device,
wherein the RRC setup request indicates a particular establishment cause that is one of a plurality of enumerated establishment causes defined for the telecommunications network,
wherein the active RRC session is configured with radio resources allocated based on the particular establishment cause;
storing a plurality of session records at a cell site database, the plurality of session
records recording an establishment cause for each of a plurality of active RRC sessions at the network node including the active RRC session initiated for the wireless device;
deploying at least a portion of a prediction model at a baseband processing unit of the network node such that the network node is configured to generate an inference based on locally using at least the portion of the prediction model,
wherein the prediction model is trained based on the plurality of session records stored at the cell site database to predict a quantity of new RRC setup requests indicating a given establishment cause and being received by the network node within an upcoming time period; and
based on the quantity of new RRC setup requests predicted by the prediction model for one or more establishment causes defined with a higher priority than the particular establishment cause, causing the active RRC session initiated for the wireless device to be offloaded to a second network node operating a different cell site.

14. The computer-implemented method of claim 13, wherein at least one of the cell site database or the prediction model is coupled to both the network node and the second network node.

15. The computer-implemented method of claim 13, further comprising:
determining whether to transition a cell site operated by the network node to an access class barring (ACB) state based on a threshold number of the active RRC sessions associated with a subset of high-priority establishment causes being satisfied; and
modifying the threshold number based on the quantity of new RRC setup requests predicted by the prediction model for the subset of high-priority establishment causes.

16. The computer-implemented method of claim 13, wherein the plurality of enumerated establishment causes contains (i) mobile-originated data, (ii) mobile-terminated access, (iii) mobile-originated signalling, or (iv) high-priority or emergency access.

17. The computer-implemented method of claim 13, wherein the prediction model comprises one or more of a gradient boosting machine, a weighted ensemble, or a random forest.

18. The computer-implemented method of claim 13, wherein the plurality of session records further records a device model for each of the plurality of active RRC sessions, and wherein the particular establishment cause is indicated in the RRC setup request by the wireless device based on a model-specific mapping.

19. The computer-implemented method of claim 13, wherein the prediction model is configured to be exclusively associated with the network node.

20. The computer-implemented method of claim 13, wherein the plurality of enumerated establishment causes includes one or more resume causes indicated when a given active RRC session was previously inactive.
